(19) United States
(12) Patent Application Publication
(10) Pub. No.: US 2025/0158371 A1
(43) Pub. Date: May 15, 2025

(54) Wire Harness Fixing Device and Wire Harness Assembly

(71) Applicants: Tyco Electronics Technology (SIP) Co., Ltd., Suzhou (CN); Tyco Electronics (Shanghai) Co., Ltd., Shanghai (CN)

(72) Inventors: Lei (Lewis) Sun, Suzhou (CN); Genquan Jia, Suzhou (CN); Neng Dong, Shanghai (CN); Renwen (Leon) Zhang, Shanghai (CN); Guomin Sun, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 18/947,653

(22) Filed: Nov. 14, 2024

(30) Foreign Application Priority Data
Nov. 14, 2023 (CN) 202323072538.7

(51) Int. Cl. H02G 3/32; B60R 16/02

(52) U.S. Cl. CPC H02G 3/32; B60R 16/0215

(57) ABSTRACT

A wire harness fixing device includes a bracket and a locking component. The bracket is adapted to accommodate a wire harness and including a locking part. The locking component is installed in the bracket and engaged with the locking part. A wire pressing portion is formed on the locking component and is adapted to press and hold the wire harness in the bracket.

### CROSS-REFERENCE TO RELATED APPLICATION

This application claims the benefit of Chinese Patent Application No. CN202323072538.7 filed on Nov. 14, 2023 in the State Intellectual Property Office of China, the whole disclosure of which is incorporated herein by reference.

### FIELD OF THE DISCLOSURE

The present invention relates to a wire harness fixing device and a wire harness assembly comprising the wire harness fixing device.

### BACKGROUND OF THE INVENTION

In the prior art, a pair of locking components that can be engaged with each other are usually used to fix the engine wire harness in the wire harness bracket. The pair of locking components are inserted into the wire harness bracket from both the upper and lower sides and engaged with each other to fix the wire harness in the wire harness bracket. However, this solution requires the use of two locking components, resulting in a complex structure, high cost, and insufficient retention force, making the wire harness prone to loosening.

### SUMMARY OF THE INVENTION

According to an embodiment of the present disclosure, a wire harness fixing device includes a bracket and a locking component. The bracket is adapted to accommodate a wire harness and including a locking part. The locking component is installed in the bracket and engaged with the locking part. A wire pressing portion is formed on the locking component and is adapted to press and hold the wire harness in the bracket.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a wire harness fixing device according to an exemplary embodiment of the present invention;

FIG. 2 shows an illustrative exploded view of a wire harness fixing device according to an exemplary embodiment of the present invention;

FIG. 3 shows an illustrative perspective view of a locking component of a wire harness fixing device according to an exemplary embodiment of the present invention;

FIG. 4 shows a vertical sectional view of a locking component of a wire harness fixing device according to an exemplary embodiment of the present invention;

FIG. 5 shows a vertical sectional view of a wire harness fixing device according to an exemplary embodiment of the present invention;

FIG. 6 shows a plan sectional view of a wire harness fixing device according to an exemplary embodiment of the present invention, where the locking component has not yet been inserted into the bracket; and

FIG. 7 shows a plan sectional view of a wire harness fixing device according to an exemplary embodiment of the present invention, in which the locking component has been inserted into the bracket.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided a wire harness fixing device. The wire harness fixing device comprises of: a bracket which is used to accommodate a wire harness and formed with a locking part; and a locking component installed in the bracket and engaged with the locking part. A wire pressing portion is formed on the locking component for pressing and holding the wire harness in the bracket.

According to another general concept of the present invention, there is provided a wiring harness assembly. The wiring harness assembly comprises a wire harness and the above wire harness fixing device. The wire harness is fixed in the wire harness fixing device.

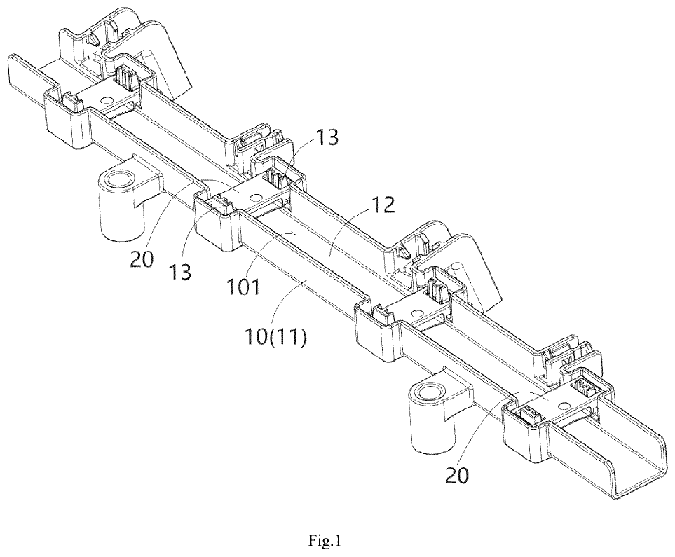

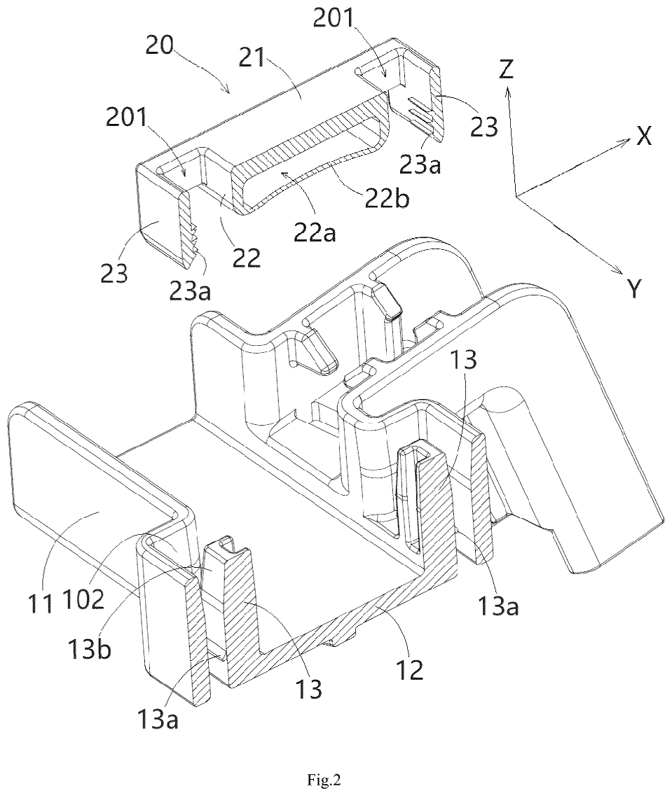

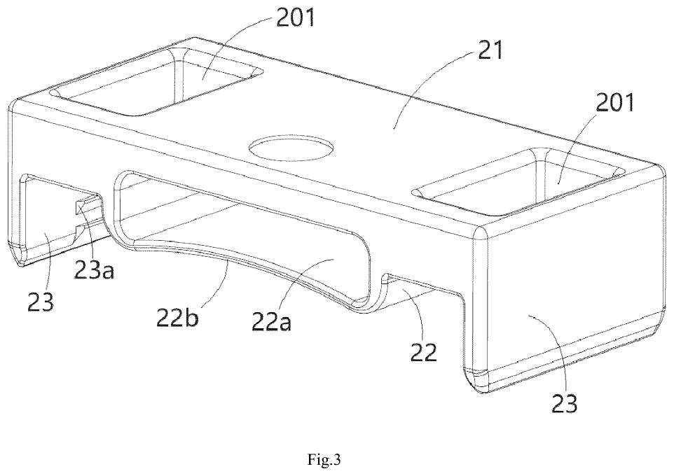

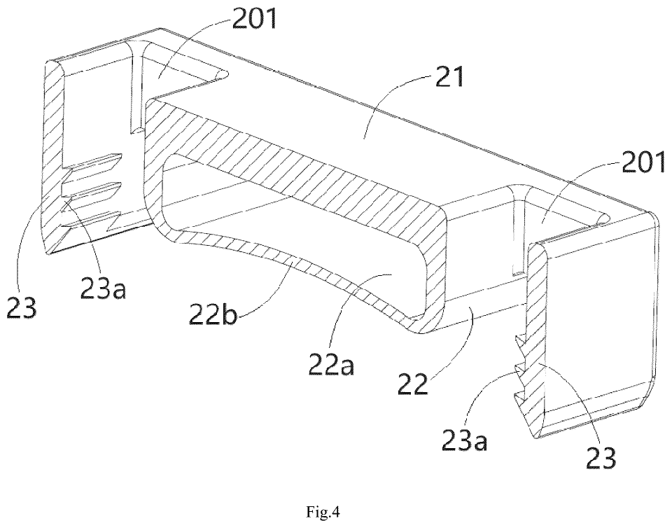

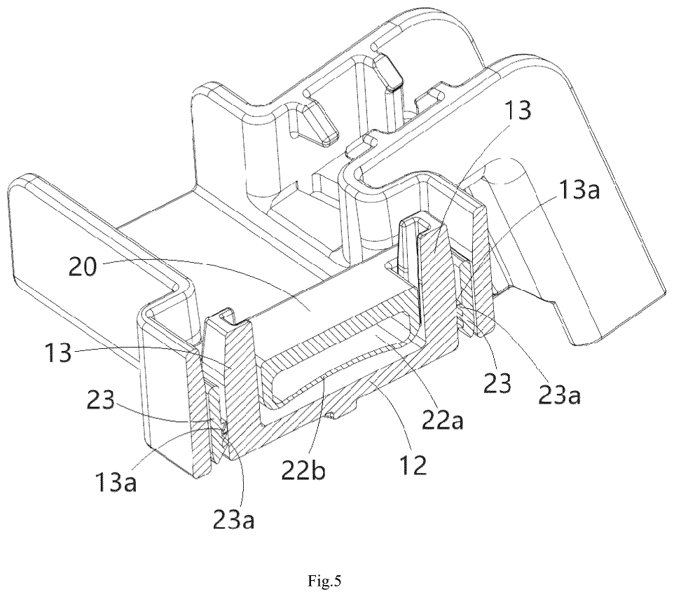

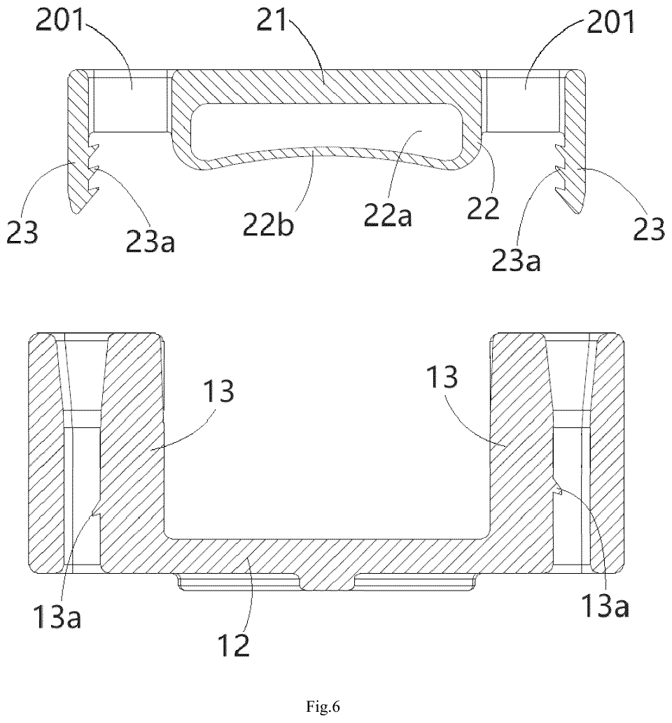

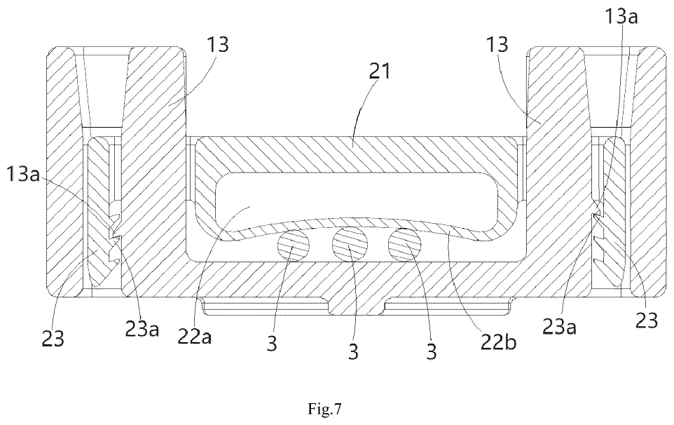

FIG. 1 shows an illustrative perspective view of a wire harness fixing device according to an exemplary embodiment of the present invention. FIG. 2 shows an illustrative exploded view of a wire harness fixing device according to an exemplary embodiment of the present invention. FIG. 3 shows an illustrative perspective view of the locking component 20 of the wire harness fixing device according to an exemplary embodiment of the present invention. FIG. 4 shows a vertical sectional view of the locking component 20 of the wire harness fixing device according to an exemplary embodiment of the present invention. FIG. 5 shows a vertical sectional view of a wire harness fixing device according to an exemplary embodiment of the present invention. FIG. 6 shows a plan sectional view of a wire harness fixing device according to an exemplary embodiment of the present invention, in which the locking component 20 has not yet been inserted into the bracket 10. FIG. 7 shows a plan sectional view of a wire harness fixing device according to an exemplary embodiment of the present invention, in which the locking component 20 has been inserted into the bracket 10.

As shown in FIGS. 1-7, in an exemplary embodiment of the present invention, a wire harness fixing device is disclosed. The wiring harness fixing device includes a bracket 10 and a locking component 20. The bracket 10 is used to accommodate the wire harness 3 and formed with a locking part 13. The locking component 20 is installed in the bracket 10 and engaged with the locking part 13. A wire pressing portion 22 is formed on the locking component 20, the wire pressing portion 22 is used to press the wire harness 3 to hold it in the bracket 10.

In the illustrated embodiment, a hollow inner cavity 22a is formed in the wire pressing portion 22, and the bottom plate 22b of the inner cavity 22a is used to press against the wire harness 3. The thickness of the bottom plate 22b of the inner cavity 22a is less than a predetermined value, so that the bottom plate 22b of the inner cavity 22a can undergo elastic deformation when pressing the wire harness 3. The thickness of the bottom plate 22b of the inner cavity 22a is not greater than 1 mm, for example, it can be 0.6 mm, 0.5 mm, or 0.4 mm.

The locking component 20 includes a main body 21 and a pair of side plates 23. There are two insertion holes 201 formed in the main body 21. The pair of side plates 23 are respectively connected to both ends of the main body 21 and respectively adjacent to two insertion holes 201. Two locking parts 13 corresponding to the two insertion holes 201 are formed in the bracket 10, and the two locking parts 13 respectively pass through the two insertion holes 201. A first strip-shaped tooth 13a is formed on the side of the locking part 13, and a second strip-shaped tooth 23a suitable for engaging with the first strip-shaped tooth 13a is formed on the side of the side plate 23.

In the illustrated embodiment, multiple second strip-shaped teeth 23 are formed on the side of the side plate 23 of the locking component 20, and the multiple second strip-shaped teeth 23 are arranged in a row along the height direction Z of the bracket 10, so that the locking component 20 can be locked at different height positions by the first strip-shaped teeth 13a on the locking part 13, to be able to hold different numbers or diameters of wire harnesses 3.

The wire pressing portion 22 protrudes from the bottom of the main body 21 of the locking component 20, and the inner cavity 22 runs through the wire pressing portion 22 along the longitudinal direction Y of the bracket 10. The bottom plate 22b of the inner cavity 22 is slightly arched upwards in an arc shape.

The bracket 10 includes a pair of side walls 11 opposite to each other in its transverse direction X and a bottom wall 12 connected between the bottoms of the pair of side walls 11. The pair of side walls 11 and the bottom wall 12 enclose a slot 101 for accommodating the wire harness 3. The wire harness 3 is suitable for being clamped and fixed between the bottom plate 22b of the locking component 20 and the bottom wall 12 of the bracket 10.

A wall recess 102 is formed on the side wall 11 of the bracket 10, and the locking part 13 is located in the wall recess 102 and extends along the height direction of the bracket 10. The two ends of the locking component 20 are respectively accommodated in the two wall recesses 102 of the bracket 10, and the locking part 13 passes through the insertion hole 201 of the locking component 20. An inclined guide slope 13b is formed on the upper end of the locking part 13 to guide the locking part 13 into the insertion hole 201 of the locking component 20.

Multiple pairs of locking parts 13 are formed in the bracket 10, and the multiple pairs of locking parts 13 are spaced apart in the longitudinal direction Y of the bracket 10. The wire harness fixing device includes multiple locking components 20, each locking component 20 is engaged with a corresponding pair of locking parts 13.

The bracket 10 is an integral formed piece, for example, the bracket 10 can be an integral injection molded part. This can reduce manufacturing costs.

In another exemplary embodiment of the present invention, a wiring harness assembly is also disclosed. The wiring harness assembly includes: a wiring harness 3 and the aforementioned wiring harness fixing device. The wire harness 3 is fixed in the wire harness fixing device.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A wire harness fixing device, comprising:
a bracket adapted to accommodate a wire harness and including a locking part; and
a locking component installed in the bracket and engaged with the locking part, a wire pressing portion is formed on the locking component and adapted to press and hold the wire harness in the bracket.

2. The wire harness fixing device according to claim 1, wherein the wire pressing portion defines a hollow inner cavity.

3. The wire harness fixing device according to claim 2, wherein the hollow inner cavity is at least partially defined by a bottom plate adapted to press against the wire harness.

4. The wire harness fixing device according to claim 2, wherein the bottom plate is adapted to elastically deform when pressing the wire harness.

5. The wire harness fixing device according to claim 4, wherein the locking component includes:
a main body formed with two insertion holes; and
a pair of side plates which are respectively connected to both ends of the main body and respectively adjacent to the two insertion holes.

6. The wire harness fixing device according to claim 5, wherein two locking parts corresponding to the two insertion holes are formed in the bracket, and the two locking parts pass through the two insertion holes respectively.

7. The wire harness fixing device according to claim 6, wherein a first strip-shaped tooth is formed on a side of the locking part, and a second strip-shaped tooth suitable for engaging with the first strip-shaped tooth is formed on a side of the side plate.

8. The wire harness fixing device according to claim 7, wherein multiple second strip-shaped teeth are formed on the side of the side plate of the locking component, the multiple second strip-shaped teeth are arranged in a row along the height direction of the bracket, such that the locking component can be locked at different height positions by the first strip-shaped teeth on the locking part, to enable the holding of different numbers or diameters of wire harnesses.

9. The wire harness fixing device according to claim 7, wherein the wire pressing portion protrudes from the bottom of the main body of the locking component, and the inner cavity runs through the wire pressing portion along the longitudinal direction of the bracket.

10. The wire harness fixing device according to claim 9, wherein the bottom plate is arched upwards in an arc shape.

11. The wire harness fixing device according to claim 7, wherein the bracket comprises a pair of side walls opposite to each other in its transverse direction and a bottom wall connected between the bottom of the pair of side walls, wherein the pair of side walls and the bottom wall enclose a slot for accommodating the wire harness.

12. The wire harness fixing device according to claim 11, wherein the wire harness is clamped and fixed between the bottom plate of the locking component and the bottom wall of the bracket.

13. The wire harness fixing device according to claim 12, wherein a wall recess is formed on the side wall of the bracket, and the locking part is located in the wall recess and extends along the height direction of the bracket.

14. The wire harness fixing device according to claim 13, wherein the two ends of the locking component are respectively accommodated in the two wall recesses of the bracket, and the locking part passes through the insertion hole in the locking component.

15. The wire harness fixing device according to claim 14, wherein an inclined guide slope is formed on the upper end of the locking part to guide the locking part into the insertion hole in the locking component.

16. The wire harness fixing device according to claim 7, wherein multiple pairs of locking parts are formed in the bracket, and the multiple pairs of locking parts are spaced apart in the longitudinal direction of the bracket.

17. The wire harness fixing device according to claim 16, wherein the wire harness fixing device comprises multiple locking components, each locking component being engaged with a corresponding pair of locking parts.

18. The wire harness fixing device according to claim 1, wherein the bracket is an integral molded piece.

19. A wiring harness assembly, comprising:
a wire harness fixing device, comprising:
a bracket adapted to accommodate a wire harness and including a locking part; and
a locking component installed in the bracket and engaged with the locking part, a wire pressing portion is formed on the locking component and adapted to press and hold the wire harness in the bracket; and
a wire harness arranged between the wire pressing portion and the locking part.

20. The wiring harness assembly of claim 19, wherein a hollow inner cavity is formed in the wire pressing portion, and a bottom plate of the inner cavity is elastically deformable by the wire harness with the wire harness arranged in the wire harness fixing device.
